(19) United States
(12) Patent Application Publication
(10) Pub. No.: US 2022/0236115 A1
(43) Pub. Date: Jul. 28, 2022

(54) METHOD AND APPARATUS FOR PIPELINE MONITORING

(71) Applicant: SHAWCOR LTD., Toronto (CA)

(72) Inventors: Dilip Tailor, Mississauga (CA); Ronald Dunn, Oakville (CA); Mark Phillip Brandon, Toronto (CA); Ahmed Hammami, Edmonton (CA); Sean Conners, Toronto (CA); Pascal Laferriere, Toronto (CA); Eric Slingerland, Calgary (CA); Dennis Wong, Toronto (CA)

(73) Assignee: SHAWCOR LTD., Toronto (CA)

(21) Appl. No.: 17/606,595

(22) PCT Filed: Apr. 24, 2020
(86) PCT No.: PCT/CA2020/050543

§ 371 Date: Oct. 26, 2021

Related U.S. Application Data
(60) Provisional application No. 62/839,597, filed on Apr. 26, 2019.

(51) Int. Cl. G01K 1/024; F17D 5/02; G01K 1/14; H04W 4/38; H04W 4/80

(52) U.S. Cl. CPC G01K 1/024; F17D 5/02; H04W 4/80; H04W 4/38; G01K 1/14

(57) ABSTRACT

A pipeline monitoring system, utilizing RFID sensors. The pipeline monitoring system includes a pipeline having at least one RFID sensor for a wireless remote detection of any one or more of pipeline conditions including hydrocarbons presence, moisture presence, temperature and strain, and an RF interrogator or transceiver capable of interrogating said sensor.

### BACKGROUND OF THE INVENTION

Deteriorating pipeline, and hydrocarbon leaks from pipelines, notably oil or gas pipelines, are of increasing concern.

Oil or gas pipelines are typically steel pipes, which are factory coated with an external epoxy and/or polyolefin coating, as well as (optionally) an insulation coating or weight coating. The pipes may also be coated internally. The coatings may be a single layer or a multiple layer coating. The coating provides corrosion resistance, impact resistance, and (optionally) temperature insulation or weight properties to the pipeline.

Oil or gas pipelines can also be manufactured from composite polymeric pipes, which may also be coated.

The pipes are typically manufactured in discrete lengths which are assembled together in the field. For coated, steel pipeline, typically, the discrete pipe lengths are coated leaving a “cutback region” at each end of the pipe length that is not coated, to facilitate the welding of the steel pipe lengths to one another. Once the steel is welded together in a “girth weld”, the uncoated cutback region is coated, in the field. Such a coating may be, for example, a layer of fusion bonded epoxy or a shrink wrapped polyolefin sleeve or a tape.

For composite pipeline, sometimes referred to as flexible pipeline, the pipe lengths are affixed together utilizing a pipe coupling. The pipe coupling may be affixed using a friction fitting, or, more typically, may be welded or fused to the pipe lengths.

The pipe joint is a common failure point in pipeline. This is at least partly because the pipes are coated in controlled, factory conditions, but the pipe joints are fabricated in the field, in less controlled, less optimum conditions, where environmental factors and human error contribute to imperfections in the coating. In steel pipeline, for example, moisture and/or air ingress can lead to corrosion of the steel pipe or girth weld. In composite polymeric pipes, imperfect bonding, seal deterioration, impact, and pressure both inside and outside of the pipe can lead to coupling failure and/or hydrocarbon leaks at the coupling/pipe interface.

The deployment of the pipelines is often in buried and/or inaccessible locations. The pipelines in service are subject numerous adverse conditions that threaten the performance and integrity of the pipelines. Some examples of issues that can compromise the operation of the pipelines include:
Temperature of the fluid being transported can fluctuate, sometimes exceeding the pipe designs temperature. This could impact the flow rates, also initiate deterioration of the pipe and coating. This can be monitored by a temperature sensing sensor.
Moisture ingress under the coating can initiate a corrosion reaction in steel pipe. In composite pipes, moisture ingress may weaken reinforcement fibers within the pipe wall, leading to pipe rupture. This can be monitored by a moisture sensing sensor.
Pipe pressure can fluctuate, which can deform the pipe, especially where pipe pressure exceeds design limits of the pipe; this may lead to fatigue stress and failure. This can be monitored by a strain sensor mounted on the pipe at appropriate location and would show changes as a direct result of internal pressure changes.
Contact with abrasive or reactive fluids travelling through the pipe can lead to the corrosion of the steel pipe or the erosion of the inside pipe wall, which may reduce the wall thickness. This means that at a given design pressure limit, the pipe wall would not withstand the hoop stress and could lead to the failure. The susceptibility of the pipe wall due to reduced wall thickness can be detected by a strain sensor, as the pipe would expand more at these points.
In case of polymer based composite pipes, high temperatures, especially if they exceed the design limits of the pipe, can soften the polymer, reduce the modulus and lead to radial expansion of the pipe. This can lead to pipe failure. The tendency of the pipe to expand more due to these temperature effects can be detected by a strain sensor.
Pipe movements due to seismic activities or due to thermal expansion of the pipes can create strain in the pipe and possibly compromise the pipe integrity. This can be detected via a strain sensor.
In concrete coated pipes, the time required for the concrete to cure properly is fairly variable, and can be influenced by parameters such as the amount of water added to the concrete, the thickness of the concrete, and the ambient temperature and moisture. This can be monitored by temperature and moisture sensors.

A failure of a pipeline can, in some cases, have severe economic impact on the pipeline operation and the supply chain. It can also, in some cases, have catastrophic environmental impact. Therefore many regulatory bodies and companies responsible for pipeline deployment are increasingly requiring monitoring of the pipelines in order to detect any adverse conditions arising before they do severe damage.

There are various monitoring systems currently being used by the industry. A common system is a fiber optic line, typically deployed along the pipeline, either attached to the external surface of the pipe, or placed in the proximity of the pipe. Attempts have been made to embed the fiber optic line in the pipeline coating, but this has been not been very successful, due to the damage incurred to the fiber due to harsh process conditions in the coating operations. The main difficulty with the current fiber optics solutions is that they are a wired system, meaning that the fiber must be continuous along the pipe, and at some terminal point(s) a transmitter and receiver, physically connected to the fiber optic cable, has to emerge from the soil above ground. An obstacle in implementing such a fiber optic line sensor system on a pipeline is at the pipeline joints, where the splicing and embedding of the fiber at the joint covering risks damaging the fiber due to the steps involved, such as grit blasting, girth welding, preheating the pipe, coating application etc. The biggest downfall for the optical fiber is that, if any one point in the fiber is damaged, the entire monitoring system becomes inoperable. Recently electrical cables with sensor capability have been introduced for hydrocarbon detection. These are based on cable insulation that is rendered conductive by incorporation of conductive fillers such as graphene, and change in the resistance is monitored resulting from hydrocarbon exposure. However, these also suffer from same issues related to the fiber optics system, namely wired system needing hard connection to gateway above ground, risks of damage at the joints, need for continuous power supply.

There is need for a sensing solution that can provide one or more of the following advantages: a wireless solution that is discrete; where the sensors can function without connection to a power supply (battery or electrical line); where the sensors can resist harsh pipeline coating application conditions as well as survive service conditions in the ground; can be monitored below ground or in a water submerged environment; and where the data generated can be acquired and processed locally on site, or transmitted to the cloud or remote distant locations. Also importantly, the base sensing technology that is utilized can be adapted to measure temperature, moisture presence, and strain.

The RFID is a well understood commercial technology. Radio frequency identification (RFID) based sensors can be utilized in the field of monitoring, detecting, tracking, and reporting at least one specific sensor based parameter. Such RFID sensors can be utilized in applications including, for example, electrical, chemical, biological, radiological, environmental, or intrusion sensing.

A RFID system consists of a reader that includes RF transmitter and receiver (transceiver), and multiple RFID transponder tags that include an antenna for communicating with the RFID reader. The RFID reader uses radio transmission to send energy to the RFID transponder tag, which in turn emits a unique identification code back to the reader. The frequencies used by RFID technology are varied ranging from 50 KHz to 2.5 GHz. RFID transponder tags come in three basic forms: passive RFID transponder tag, battery assisted passive RFID transponder tag and active RFID transponder tag.

Passive RFID transponder tags do not contain a battery. The power is supplied by the RFID reader/interrogator. When radio waves from the RFID reader are encountered by a passive RFID transponder tag, the coiled antenna within the tag forms a magnetic field. The passive RFID transponder tag draws power from it, energizing the circuits in the tag. The passive RFID transponder tag then sends the information encoded in the tag's memory back to the RFID reader. Passive tags are extremely cheap, small, and light. They have very high reliability, are extremely robust, and have high autonomy as the electronic units are powered through an RF link. However, passive tags typically have interrogation distances of less than 5 m.

Battery-assisted passive RFID transponders are tags that also reflects signal back to the RFID reader but use an on-board battery to either boost the tag's read range or to run the circuitry on the chip or a sensor integrated with the transponder tag. These are sometimes referred to as semi-passive RFID tags, since they typically still use the backscattered communication for interrogation.

Active RFID transponder is a tag when it is equipped with a battery that can be used as a partial or complete source of power for the tag's circuitry and antenna. Some active RFID transponder tags contain replaceable batteries for years of use; others are sealed units. RFID transponder tag also comes with read-only, write-once-read-many, or read/write capabilities. Active RFID tags, have relatively lower resistance to harsh environments (as compared to passive or semi-passive tags), but can have interrogation distances of up to several kilometers. Semi-passive RFID tags have their own battery to power the circuitry but no radio transmitters, and still use backscattered communication for interrogation.

Various types of RFID reader have been disclosed in the related art. For example, U.S. Pat. No. 6,523,752 to Hiroyuki Nishitani, et al. (incorporated herein by reference) reveals a RFID reader/communications apparatus used in delivery sorting of delivery articles such as parcel post and home delivery freight. Another example is U.S. Pat. No. 6,415,978 to Charke W. McAllister (incorporated herein by reference) that explains a multiple technology data reader for reading barcode labels and RFID tags. Similarly, U.S. Pat. No. 6,264,106 to Raj Bridgelall (incorporated herein by reference) discusses a circuit that combines the functionality of a bar code scanner and a RFID circuit. The Patent Application Publication No.: US 2009/0218891 AI by Norman D. McCollough, JR (incorporated herein by reference) describes an RFID device comprising an energy harvesting and storing system that receives available RF energy and uses the available RF energy to power the RFID device.

Although RFID and sensor integrated systems were not widely discussed in the prior art, several stand-alone sensor measuring systems are revealed. U.S. Pat. Nos. 6,503,701, 6,322,963 and 6,342,347, all to Alan Joseph Bauer, (and all incorporated herein by reference) presents an invention related to a sensor for analyte detection. The sensor makes use of changes in electrostatic field associated with macromolecular binding agents during their interaction with analytes. Henry R. Pellerin in U.S. Pat. No. 6,411,916 (incorporated herein by reference) discloses a method of tracking and monitoring the temperature of a food product from point of origin until it is removed from the display case by the consumer for immediate transport to the point of sale. U.S. Pat. Nos. 6,428,748 and 6,576,474, all to Donald F. H. Wallach, explains a detector for monitoring an analyte includes an analyte-sensing composition which has visible color intensity or emission intensity that changes as analyte concentration contacting the detector changes. Evangelyn C. Alocilja et al. in U.S. Pat. No. 6,537,802 reveals a method and apparatus for detection of a small amount of volatile products from a sample using a transducer which changes voltage as a function of contact of the volatile product with the transducer, and John T. McDevitt et al. in U.S. Pat. No. 6,649,403 explains a method for preparing a sensor array formed from a plurality of cavities. In U.S. Pat. No. 6,577,969, Kazumi Takeda et al. also discusses a food safety administration system for controlling safety of food handling locations, and Abtar Singh et al. in U.S. Pat. No. 6,549,135 explains a system to provide for monitoring the food product of a remote retailer via a communication network.

In a patent publication related to pipeline monitoring, US 2013/0043887, to A I Ziolkowski et al (incorporated herein by reference) describes a method for underground pipeline monitoring in which a continuous alternating electrical current having a current frequency in a range of about 1 kHZ to about 8 kHz is imparted onto a pipeline, producing an alternating magnetic field at the current frequency along the pipeline. Distributed along the pipeline is a network of RFID tag sensors which absorb an amount of energy from the alternating magnetic field. The impedance of the sensors is modulated, producing a modulated sensor impedance which is detected at a location proximate the location at which the continuous alternating electrical current is imparted onto the pipeline. This patent shows the need for viable practical system to monitor pipeline wirelessly, and it uses electricity transmitting through the whole pipeline.

The need for sensing and monitoring pipelines is also highlighted in U.S. Pat. No. 8,844,577 B2 Larry W. Kiest, Jr, (incorporated herein by reference) where the pipe is monitored for manufacturing and repair quality level after installation in order to assure performance compliance. This patent utilizes the RFID tag in the conventional manner, to identify the sensor number and the location, essentially providing a unique identification for that section of pipe. However, the RFID is not used as a sensor: for measuring physical parameters, the patent describes use of electro-mechanical sensors such as a pressure sensor, a sensor for measuring distance, a load cell, a temperature sensor, a strain gauge, an accelerometer, a flow meter, a chemical sensor etc. In this recent patent, the inventor fails to recognize the utility of a RFID ID tag combined with physical measurement sensor for pipeline monitoring.

Similarly in the U.S. Pat. No. 9,038,670 B2, (incorporated herein by reference) Bernard Roy teaches use of RFID tags for ID, location and tracking of polymeric pipes buried underground. He describes the manufacturing of the pipe with the method of embedding the tags. The tags allows identification and location of the pipe from above ground. However, the patent does not teach using the tags as sensors for physical measurements. For example, it states that “in the gas sector, where the polyethylene is already widely present for reasons of reliability, the invention provides an adequate response to a persistent demand of gas distributors: localization and traceability from the surface and for obvious reasons of improving the safety of underground networks. The invention thus provides a major advantage for polymer pipes buried underground, since those pipes can firstly be localized and secondly can communicate. These pipelines achieves the possibility to exchange information such as identity, characteristics and localization which becomes available from the surface. Traceability is greatly enhanced.”

RFID readers, RFID tags, sensors and related systems mentioned in the above patents lack the capabilities of sensing physical parameters of environment, such as temperature, humidity, strain, particularly using battery less passive sensors. In addition, RFID systems mentioned in these patents cannot be used in particularly harsh pipeline manufacturing and operational conditions as described earlier.

### BRIEF DESCRIPTION OF THE FIGURES

FIGS. 1A-1C are schematic representations of a sensor of the present invention.

FIG. 2 is a schematic cross-sectional representation of invention pipeline.

FIG. 3 is a schematic cross-sectional representation of a pipeline having sensors.

FIG. 4 is a schematic, cross-sectional representation of a pipeline having sensors.

FIG. 5 is a schematic, cross-sectional representation of an pipeline having sensors.

FIG. 6 is a schematic, cross-sectional representation of a pipeline having sensors.

FIG. 7 is a schematic, perspective view of a pipe coupling.

FIG. 8 shows a schematic, cross-sectional representation of a pipe girth weld.

FIG. 9 shows a schematic, cross-sectional representation of a pipe girth weld.

FIG. 10 shows a schematic illustration of a sleeve of the present invention.

FIG. 11 shows a further schematic illustration of a sleeve of the present invention.

FIG. 12 shows a schematic, cross-sectional representation of a steel pipe girth weld.

FIG. 13 shows a schematic, cross-sectional representation of a steel pipe girth weld having a coating and sensors.

FIG. 14 shows a schematic perspective view of a pipeline.

FIG. 15 shows a schematic illustration of a buried pipeline having sensors and a method of interrogating same.

FIG. 16 shows a schematic illustration of a buried pipeline having sensors and an alternative method of interrogating same.

FIG. 17 shows a schematic illustration of a buried pipeline having sensors and an alternative method of interrogating same.

FIG. 18 shows a schematic illustration of a buried pipeline having sensors and an alternative method of interrogating same.

FIG. 19 shows a schematic cross-sectional view of a PIG RFID interrogator within a pipeline, for use with the sensors and method of the present invention.

FIG. 20 shows a tape containing sensors of the present invention.

FIG. 21 shows a clamp having sensors as depicted in the present invention.

FIG. 22 shows a method of applying a sensor onto a buried pipe.

### SUMMARY OF THE INVENTION

To overcome above-mentioned limitations and performance requirements, a need exists for a RFID sensor system that comprises a passive sensor, having a small ultra-low thickness and flat profile that can be embedded in the steel pipeline coatings, polymer based composite pipe layers and connections. Pipelines manufactured with RFID-integrated sensor tags, can be configured with intelligent-agent based software, wireless communication networks, Internet, Intranet, and Extranet links which can process identification, sensing, and location data concurrently, and has wireless communication capabilities for acquisition, processing and transmission of information to remote stations or devices, for example via cellular, satellite or ethernet transmission.

According to a first aspect of the present invention is provided a sensor tag comprising a hydrocarbon-sensitive cover-film.

In certain embodiments, the hydrocarbon-sensitive cover-film is ethylene vinyl acteate (EVA).

In certain embodiments, the hydrocarbon-sensitive substrate is silicone.

In certain embodiments, the hydrocarbon-sensitive substrate is a styrene butadiene rubber (SBR), such as a Kraton™ Rubber (Kraton Polymers, USA).

In certain embodiments, the hydrocarbon-sensitive substrate is a is EVA, silicone or SBR filled with a conductive filler such as carbon black, carbon nanotubes, graphene or a metallic powder filler.

According to a first aspect of the present invention is provided an RFID tag sensor comprising a sensor as hereinbefore described.

According to a further aspect of the present invention is provided a pipeline coupling comprising an RFID tag sensor as hereinbefore described.

According to a further aspect, the RFID tag sensor is located on an interior surface of the coupling, distal to a pair of weld points circumscribing the interior of the coupling.

According to a further aspect, the RFID tag sensor is located on an exterior surface of the coupling.

According to a further aspect, the coupling further comprises an RFID tag moisture sensor on an interior surface of the coupling, between a pair of weld points circumscribing the interior of the coupling.

In yet a further aspect of the present invention is provided a heat shrinkable sleeve comprising an RFID tag sensor as hereinbefore described.

According to a further aspect, the shrinkable sleeve comprises an inner adhesive layer and an outer pre-stretched, heat shrinkable polyolefin layer.

According to yet a further aspect, the RFID tag sensor is partially imbedded in, or affixed to, the inner adhesive layer.

According to yet a further aspect, the RFID tag sensor is partially imbedded in, or affixed to, the outer pre-stretched, heat shrinkable polyolefin layer.

According to yet a further aspect, the shrinkable sleeve further comprises an RFID tag moisture sensor.

According to yet a further aspect, the RFID tag sensor is partially imbedded in, or affixed to, the outer pre-stretched, heat shrinkable polyolefin layer.

In yet a further aspect of the present invention is provided a pipeline monitoring system for an underground pipeline having a plurality of couplings or sleeves as hereinbefore described, comprising: a plurality of above-ground RFID sensing stations, each located proximal to one of said plurality of couplings or sleeves, said RFID sensing stations comprising an RF interrogator or transceiver capable of interrogating the RFID tag sensor located on said coupling, and a wireless signal sending means for sending a signal correlating to said interrogation to a remote base station.

According to a further aspect, the wireless signal sending means comprises a cellular transmitter and antenna.

According to one aspect of the present invention is provided a pipeline monitoring system, comprising: a pipeline having at least one RFID sensor for a wireless remote detection of any one or more of pipeline conditions including hydrocarbons presence, moisture presence, temperature and strain; and an RF interrogator or transceiver capable of interrogating said sensor.

In certain embodiments, the pipeline monitoring system further comprises a controller for said RF interrogator or transceiver, a memory for storing data received from said interrogating, and a power source for powering said RF interrogator or transceiver and said controller.

In certain embodiments, the RF interrogator or transceiver is positioned in the vicinity of the pipeline.

In certain embodiments, the pipeline is a buried pipeline and the RF interrogator or transceiver is positioned above ground.

In certain embodiments, the RF interrogator or transceiver is mounted on an inspection pig, capable of travelling within the pipeline and capable of interrogating said sensor.

In certain embodiments, the wireless signal sending means comprises a cellular, satellite or ethernet transmitter and optionally an antenna.

In certain embodiments, the pipeline is or comprises a coated steel pipe.

In certain embodiments, the pipeline is or comprises a composite or plastic pipe.

In certain embodiments, the sensor is placed on, in, or proximal to a joint section of the pipeline.

In certain embodiments, the sensor is placed on, in, or proximal to a mainline section of the pipeline.

In certain embodiments, the RFID sensor utilized in the pipeline monitoring system comprises a hydrocarbon-sensitive cover-film.

In certain embodiments, the hydrocarbon-sensitive cover-film comprises silicone, ethylene vinyl acetate or a styrene butadiene rubber.

In certain embodiments, the RFID sensor utilized in the pipeline monitoring system comprises a moisture sensitive chip and a cover film.

In certain embodiments, the RFID sensor utilized in the pipeline monitoring system comprises a temperature sensitive cover-film.

In certain embodiments, the RFID sensor is reversible to the presence or absence of moisture; in other embodiments, the RFID sensor is irreversible to the presence or absence of moisture.

In certain embodiments, the pipeline monitoring system has an RFID strain sensor, for example an RFID sensor with a strain sensitive microchip, and/or a conductive crosslinked polymer, for example silicone filled with a conductive filler such as carbon black, carbon nanotubes, graphene and/or a metallic powder.

In certain embodiments, the pipeline monitoring system has an RFID sensor which comprises a microchip combined with an antenna.

According to yet another aspect of the present invention is provided a coated or insulated pipe comprising an RFID sensor as hereindescribed. In certain embodiments, the RFID sensor is imbedded in or under the coating, or mounted on top of the coating.

According to yet another aspect of the present invention is provided a multilayered composite or plastic pipe comprising an RFID sensor as hereindescribed. In certain embodiments, the RFID sensor is imbedded in or between any of the layers or on top of the pipe.

According to yet another aspect of the present invention is provided a pipeline coupling comprising an RFID sensor as hereindescribed. In certain embodiments the RFID sensor is located on an interior surface of the coupling, distal to a pair of weld points circumscribing the interior of the coupling. In certain embodiments, the RFID sensor is located on an exterior surface of the coupling.

According to yet another aspect of the present invention is provided a heat shrinkable sleeve comprising an RFID sensor as hereindescribed. In certain embodiments, the shrinkable sleeve comprises an inner adhesive layer and an outer pre-stretched, heat shrinkable polyolefin layer. In certain embodiments the RFID sensor is partially imbedded in, or affixed to, the inner adhesive layer. In certain embodiments, the RFID sensor is partially imbedded in, or affixed to, the outer pre-stretched, heat shrinkable polyolefin layer.

According to yet a further aspect of the present invention is provided a pipeline monitoring system for an underground pipeline having a plurality of couplings or plurality of sleeves of any one of the preceding claims, comprising: a plurality of above-ground RFID sensing stations, each located proximal to the pipes and to one of said plurality of couplings or sleeves, said RFID sensing stations comprising an RF interrogator or transceiver capable of interrogating the RFID sensor located on said pipe, coupling or sleeve; and a wireless signal sending means for sending a signal correlating to said interrogation to a remote base station.

In certain embodiments, the wireless signal sending means comprises a cellular transmitter and antenna.

### DETAILED DESCRIPTION

It has been discovered that the RFID tag sensors designed specifically for pipeline applications can provide sensing capabilities for moisture, strain, temperature, and presence of hydrocarbon. They can be designed with any one or more of 6 desirable characteristics:
wireless
battery-less
miniature size, i.e. 3-3000 microns thickness, preferably less than 1000 microns, to facilitate embedding the sensor in the pipe coatings (in the case of either a steel or composite pipe), or inside the composite pipe wall
designed to withstand harsh process conditions during manufacturing, such as elevated temperatures and pressures
small and discrete, which allows the placement of the RFID tag sensors on or in any area of the pipe with ease, such as at 12, 3, 6, and 9 o'clock positions around the circumference of the pipe, as well as longitudinally anywhere along the pipe, whether it is intermittently every 1 meter or every 100 meters, at any desired distance, or randomly interspersed. The sensors may be advantageously configured for application on complex configurations, such as pipeline joints and couplings.
The RFID sensors can be configured to be capable of being read/interrogated at distances of 0.01 m to 3 meters or more. The interrogator infrastructure can be configured to read easily accessible above-ground structures, or inaccessible, buried structures.

RFID Sensors

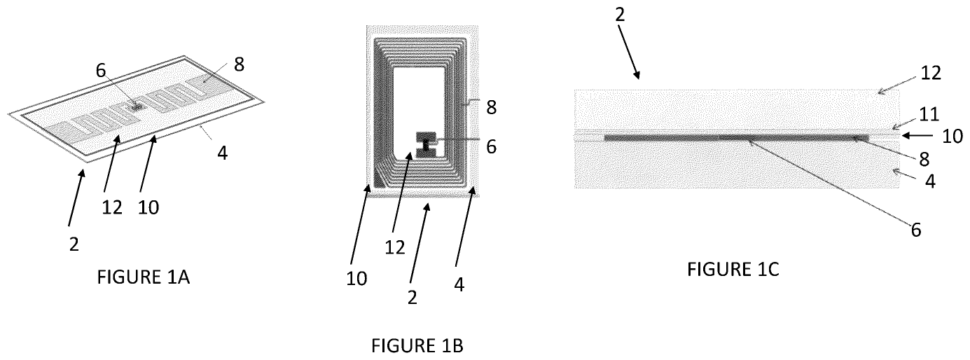

FIGS. 1A and 1B show a perspective view and a top view, respectively, of two common configurations of known RFID sensors. FIG. 1C shows a cross-sectional view of a similar sensor. RFID sensor 2 comprises a carrier substrate 4, such as a mylar film, on which a chip 6 and a tag antenna 8 are located. The chip 6 and tag antenna 8 are on an inlay 10 (with adhesive 11), which is attached to the carrier substrate 4. RFID sensors typically comprise a cover-film 12 over top of the chip 6 and tag antenna 8; this cover-film 12 may be functional (in the case of an RFID sensor) and may be non-functional (in the case of a non-sensor RFID tag).

Moisture-sensing RFID sensors are known. One such example is the RFM2121-AFR sensor tag (Axzon, Austin, Tex.), which uses a water absorbing paper cover-film over the chip 6. When exposed to water, the water absorbing paper cover-film takes in and holds water, changing the electromagnetic field or permittivity around the sensor chip. When the RFID sensor is “read” by an interrogator, the signal is different based on whether or not the water absorbing paper cover-film has, or has not, absorbed water. In this manner, the RFID sensor can easily be utilized to determine whether it has come into contact with water. Interestingly, known moisture-sensing RFID sensors are “reversible”, in that if the moisture disappears, the water absorbing paper cover film dries, and shows no moisture.

Temperature-sensing RFID sensors are also known, for example the RFM3200-AFR sensor tag manufactured by Axzon (Austin, Tex.). Interrogation of this chip will provide a local temperature reading.

Strain sensing RFID sensor/tags are also known, for example the Structural Health Monitoring (SHM) Strain Sensor available from Phase IV Engineering Inc., (Boulder, Colo.). This is based on electromechanical mechanics. In some examples of strain sensing RFID sensors, the cover-film is made from a silicone based material incorporated with a conductive filler, such as carbon nanotubes or other carbon or metal particulate are used. The filler imparts some degree of conductivity to the sensor film, which can be measured as electrical resistance. When the sensor is subjected to strain, the cover-film will expand, causing the filler particulates to separate from one another slightly, increasing resistance. Some studies have shown that, for some sensors, there is linearity between the strain and resistance within a certain range of strain. See for example, “Benchirouf, A et al., “Investigation of RFID passive strain sensors based on carbon nanotubes using inkjet printing technology”, IEEE International Multi-Conference on Signals, Systems and Devices. 2012. 1-6.10.1109/SSD.2012.6198081 (incorporated herein by reference).

Hydrocarbon Sensing RFID Sensor Tags

Disclosed herein is a hydrocarbon sensing RFID sensor tag.

The hydrocarbon sensing RFID sensor tag 2 comprises a conventional chip 6 and tag antenna 8 configuration, on a wet or dry inlay 10 on top of a carrier substrate 4. The hydrocarbon-sensing RFID sensor tag 2 comprises a hydrocarbon sensitive cover-film 12. The cover-film 12 is configured such that it can take in and hold hydrocarbon, effectively changing the electromagnetic field or permittivity around the sensor chip. In one embodiment, the cover-film 12 is made from or comprises silicone. In other embodiments, the cover film may be made from or comprise ethylene vinyl acetate (EVA) and/or a styrene butadiene rubber (SBR) which will either swell or dissolve in the hydrocarbon.

In certain embodiments, the cover-film 12 is or comprises EVA, silicone, and/or SBR, incorporating a conductive filler such as carbon black, carbon nanotubes, graphene or a metallic powder filler. In these embodiments, cover-film 12 will undergo a change in electrical resistance upon swelling or dissolving, thus changing the electromagnetic field around the sensor chip and resulting in a change in the frequency resonance.

The hydrocarbon sensing RFID sensor tag of the present invention can be manufactured as a “reversible” sensor, for example, by using a base such as silicone, which will swell upon contact with hydrocarbon, but which will return to its original size when the hydrocarbon is no longer present.

The hydrocarbon sensing RFID sensor tag can also be manufactured as an “irreversible” sensor—by utilizing a material for the cover-film 12 which will dissolve, gasify, and/or dissipate upon presence of the hydrocarbon. When the hydrocarbon is no longer present, this type of sensor will not return to its original state, rather, will be permanently indicating that it has, at some point, come into contact with hydrocarbon.

Hydrocarbon sensing RFID sensor tags are incredibly useful to sense and detect hydrocarbon leaks from pipelines, as described further, below.

Irreversible Moisture Sensing RFID Sensor Tags

Also disclosed herein is an irreversible, moisture-sensing RFID sensor tag.

Reversible moisture-sensing RFID sensor tags are known, for example, the RFM2121-AFR sensor tag (Axzon, Austin, Tex.), which uses a water absorbing paper cover-film 12.

However, it has been found that an irreversible moisture-sensing RFID sensor tag is desirable, especially in certain oil/gas pipeline applications.

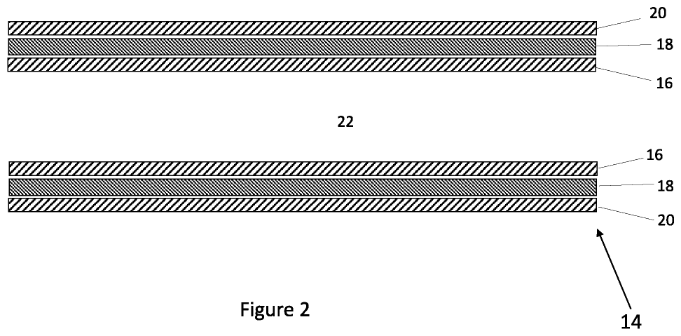

A typical composite pipe section is shown, in a non-scale, schematic cross-section, in FIG. 2. Pipe section 14 is a laminate comprising an inner layer 16, typically made from polyolefin such as polyethylene, an intermediate layer 18, typically made from glass, aramid, carbon fibre, or steel lengths, and an outer layer 20, typically made from polyolefin such as polyethylene, all surrounding an oil or gas-carrying conduit 22. Intermediate layer 18 is a reinforcing layer which provides critical stress and hoop strain resistance. In such pipes, a well known source of failure is moisture in the intermediate layer 18. Such moisture can degrade the intermediate layer 18, causing pipe failure. Interestingly, it has been found that even if the intermediate layer 18 is currently dry, if it has been exposed to moisture at any point, there may be residual reduction in strength, such as from corrosion in steel reinforcements.

Accordingly, though reversible moisture-sensing RFID sensor tags might be somewhat useful, there was a need for an irreversible moisture-sensing RFID sensor tag. Such a tag, placed on the outside of the inner layer 16, within the intermediate layer 18, or on the inside of the outer layer 20, would be able to sense whether the intermediate layer 18 has ever come into contact with moisture.

The tag can be applied, for example, by adhesively affixing it to the inner layer 16 before application of the intermediate layer 18 during manufacture of the pipe. A plurality of tags can be utilized, placed at intervals along the length of the pipe, and/or circumferentially around the pipe, to record and measure moisture in a plurality of locations within intermediate layer 18.

The irreversible moisture-sensing RFID sensor tag 2 comprises a conventional chip 6 and tag antenna 8 configuration, on a wet or dry inlay 10 on top of a carrier substrate 4. The RFID sensor tag 2 comprises a moisture sensitive cover-film 12. The cover-film 12 is configured such that it irreversibly dissolves, gasifies, and/or dissipates upon presence of moisture, effectively changing the electromagnetic field or permittivity around the sensor chip. In one embodiment, the cover-film 12 is made from or comprises sodium bicarbonate. In other embodiments, the cover film may be made from or comprise an alkali metal which will either burn or irreversibly evaporate in water. In further embodiments, the cover film can comprise iron or mild steel which will irreversibly oxidize in the presence of water. The cover film made with PVA (Poly vinyl alcohol) softens up slightly due to water absorption in limited water exposure (as would be the case inside the pipe annulus), but will reverse upon drying up. It was found that when the PVA was compounded with gelatin or glycerine, the new compound more readily went into solution and collapsed, losing its structure and thickness, this providing a permanent change.

In some applications, it may be useful to have a hybrid sensor, having PVA (Poly vinyl alcohol) or another reversible moisture sensing cover film containing iron or another irreversible cover-film, which would provide the best of both.

Applications for RFID-based Sensors in Pipeline

Known RFID-based moisture, temperature or strain sensors may be utilized, either alone or, for example, in combination with or addition to the hydrocarbon sensors and/or the irreversible moisture sensors as hereinbefore described, to provide additional information regarding the integrity of the pipe at or around the point being sensed. For example, a leak causing a positive reading from a hydrocarbon sensor can be confirmed by a change in temperature in the area of the leak, or an increase in strain. Smart algorithms and machine learning can be utilized, over time, as the data acquired from the sensors increases.

Application 1: Multilayer Composite Pipe

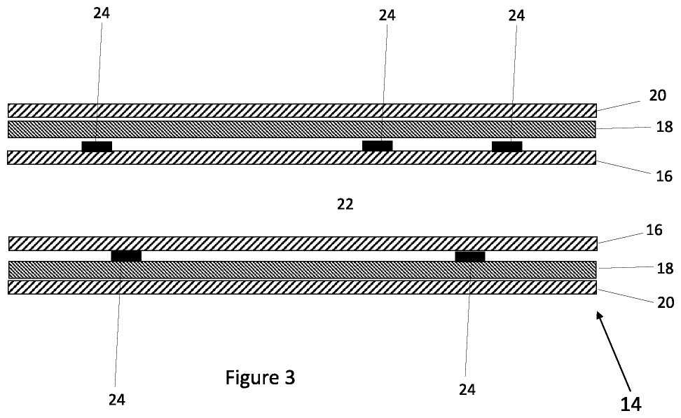

FIG. 3 shows a non-scale schematic cross-sectional representation of a composite pipe section 14 configured with sensor RFID tags 24 according to one embodiment of the present invention.

Pipe section 14 is a laminate comprising an inner layer 16, typically made from polyolefin such as polyethylene, an intermediate layer 18, typically made from glass, aramid, carbon fibre, or steel lengths, and an outer layer 20, typically made from polyolefin such as polyethylene, all surrounding an oil, water or gas-carrying conduit 22. Intermediate layer 18 is a reinforcing layer which provides critical stress and hoop strain resistance. In such pipes, a well known source of failure is moisture in the intermediate layer 18. Such moisture can degrade the intermediate layer 18, causing pipe failure. Interestingly, it has been found that even if the intermediate layer 18 is currently dry, if it has been exposed to moisture at any point, there may be residual reduction in strength, such as from corrosion in steel reinforcements.

Pipe section 14 is typically made by extruding inner layer 16, wrapping it with fibre to form intermediate layer 18, then extruding outer layer 20 over top of the intermediate layer 18.

Sensor RFID tags 24 may be affixed to inner layer 16 before wrapping it with fibre. Sensor RFID tags 24 may be affixed at various locations along the pipe, as shown. In certain embodiments, Sensor RFID tags 24 have unique identifiers as well as the sensor, which may be used to determine the location of the RFID tag 24. In certain embodiments, the sensor RFID tags 24 are moisture sensing RFID tags as hereindescribed, for example, irreversible moisture sensing RFID tags. In certain embodiments, the RFID tag 24 may comprise an adhesive backing for affixing to inner layer 16. In other embodiments, RFID tag 24 may be pushed or otherwise set into inner layer 16 before the inner layer 16 has completely gelled.

In certain embodiments, the sensor RFID tags 24 may be hydrocarbon sensors, moisture sensors, strain sensors, and/or temperature sensors.

Application 2: RFID Tag in Insulated Pipe

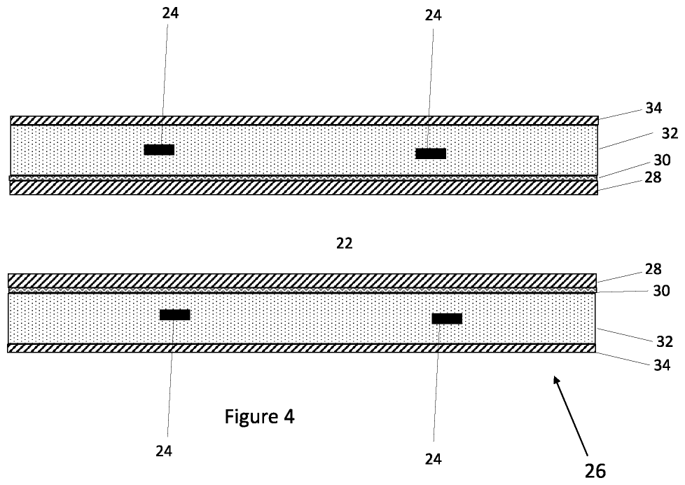

FIG. 4 shows a non-scale schematic cross-sectional representation of an insulated steel oil or gas pipe 26 configured with sensor RFID tags 24 according to one embodiment of the present invention.

Pipe section 26 comprising an inner steel pipe layer 28, typically coated in a thin fusion bonded epoxy coating 30, followed by a layer of insulation 32. The insulation layer is coated in a protective top coat 34. Typically, the insulation layer 32 is a foam insulation, which insulates the conduit 22 to prevent loss of heat from the fluid therein.

Moisture within the insulation layer 32 can be devastating to the insulative effects of the layer, causing detrimental heat loss (for example), which is undesirable. Interestingly, it has been found that even if the insulation layer 32 is currently dry, if it has been exposed to moisture at any point, there is significant chance of a decrease in its insulative properties.

Pipe section 14 is typically made by coating the outer surface of the steel pipe layer 28 with a fusion bonded epoxy coating 30, then applying a foamed insulation 32. RFID tags 24 may be inserted into the foamed insulation 32 before it has set. The set foamed insulation layer 32 is then coated with a protective top coat 34, typically a polyethylene layer.

Because the RFID tags 24 can have unique identifiers, they can be placed semi-randomly within the insulation layer 32, and mapped after the pipe section is made. A plurality of RFID tags 24 may be placed at varying intervals within the insulation layer 32. In certain embodiments, the sensor RFID tags 24 are moisture sensing RFID tags as hereindescribed, for example, irreversible moisture sensing RFID tags. In certain embodiments, the RFID tag 24 may comprise an adhesive backing for affixing to inner layer 16.

In certain embodiments, the sensor RFID tags 24 may be hydrocarbon sensors, moisture sensors, strain sensors, and/or temperature sensors.

Application 3: RFID Tag in 3-layer Polyolefin Coated Pipe

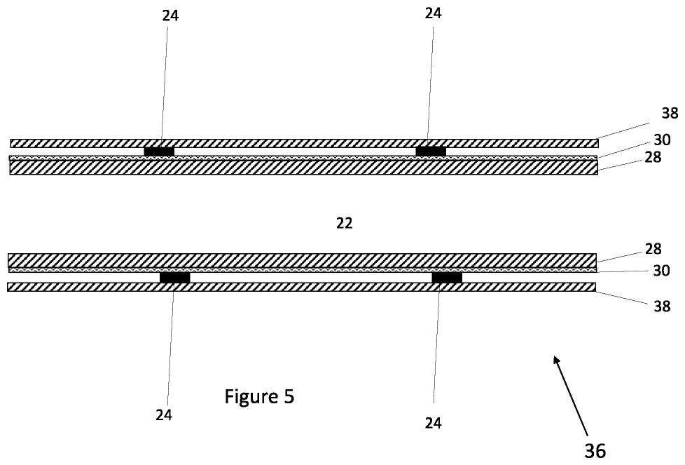

FIG. 5 shows a non-scale schematic cross-sectional representation of a 3-layer polyolefin coated steel oil or gas pipe 36 configured with sensor RFID tags 24 according to one embodiment of the present invention.

Pipe section 36 comprising an inner steel pipe layer 28, typically coated in a thin fusion bonded epoxy coating 30, followed by an outer polyolefin layer 38, which is typically polyethylene, or polyethylene and adhesive, either combined or in two layers.

Moisture between the outer polyolefin layer 38 and the FBE layer 30 has been found to increase the probability of corrosion and/or pipe failure. The presence of hydrocarbon between the outer polyolefin layer 38 and the FBE layer 30 is an indicator of a leak in the pipe.

Pipe section 14 is typically made by coating the outer surface of the steel pipe layer 28 with a fusion bonded epoxy coating 30, then applying the outer polyolefin layer 38 by extrusion. RFID tags 24 may be inserted into the FBE layer 30 before it has set, or may be attached to the FBE layer 30 using adhesive. The set FBE layer 30 is then coated with the outer polyolefin layer 38.

Because the RFID tags 24 can have unique identifiers, they can be placed semi-randomly within the FBE layer 30, and mapped after the pipe section is made. A plurality of RFID tags 24 may be placed at varying intervals within the FBE layer 30. In certain embodiments, the sensor RFID tags 24 are moisture sensing RFID tags as hereindescribed, for example, irreversible moisture sensing RFID tags. In certain embodiments, the RFID tag 24 may comprise an adhesive backing for affixing to inner layer 16. In certain embodiments, the sensor RFID tags 24 may be hydrocarbon sensors, moisture sensors, strain sensors, and/or temperature sensors.

Application 4: RFID Tag in Concrete Coated Pipe

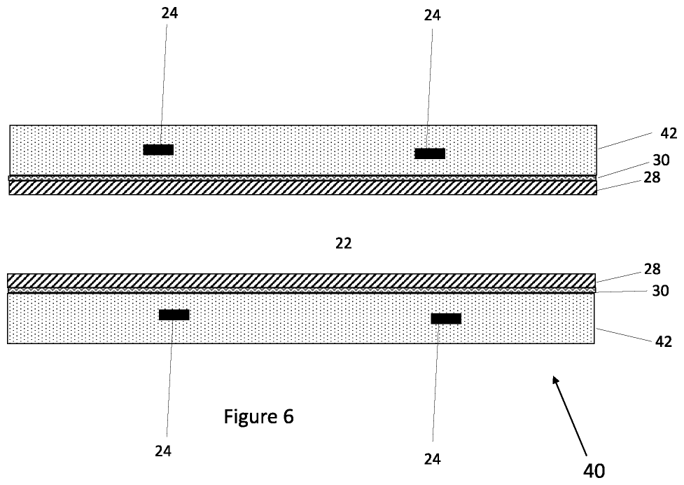

FIG. 6 shows a non-scale schematic cross-sectional representation of a concrete coated pipe. Concrete weight coatings are commonly used in offshore pipeline, for example.

Concrete pipe section 40 comprising an inner steel pipe layer 28, typically coated in a thin fusion bonded epoxy coating 30, followed by a concrete coating 42.

One of the problems with manufacturing a concrete-coated pipe is determining when the concrete has cured sufficiently. Improper or incomplete curing can lead to damage of the concrete pipe as it is transported. Thus concrete pipes are typically conservatively cured, for longer periods than the minimum required, to ensure they are properly cured. This adds time (and resultant expense) to the manufacture and installation process.

Proper cure can be measured by the amount of moisture within the concrete. However, this is difficult to measure (other than at the surface) for a partially-cured pipe.

Moisture sensing RFID sensors 24, placed within the concrete coating, enable the manufacturer to measure the moisture of the concrete within the coating, to ensure the concrete is properly cured before handling. It also allows documentation of such moisture levels for quality control purposes.

Because the RFID tags 24 can have unique identifiers, they can be placed semi-randomly within the concrete coating layer 42, before the concrete has set. They may be placed at varying depths, and varying locations within the concrete coating layer 42. In certain embodiments, the sensor RFID tags 24 are moisture sensing RFID tags as hereindescribed, for example, reversible moisture sensing RFID tags. In certain embodiments, the sensor RFID tags 24 may be hydrocarbon sensors, moisture sensors, strain sensors, and/or temperature sensors, for use after the pipe has been installed and deployed.

Application 5: RFID Tag in Composite Pipe Coupling

First pipe length 44 and second pipe length 46 are affixed together to form a single conduit, utilizing pipe coupling 48. Pipe coupling 48 is made of a similar or identical material to pipe lengths 44, 46, and is heat welded to each at a weld point (not shown). Pipe coupling 48 may comprise heating elements (not shown) which surround its inner diameter, to which an electric current is flowed, which heats and fuses the pipe coupling 48 to each of pipe lengths 44, 46, forming a coupling impervious to both hydrocarbon and water. Alternatively, rather than utilizing heating elements to which an electric source must be connected, an iron-containing metallic element may be used, which may be heated inductively. For example, a set of wire mesh may surround the inner diameter of the pipe coupling 48; an inductive heat source may be used to heat said wire mesh, fusing the pipe coupling 48 to each pipe length 44, 46. Pipe coupling 48 may also, either in an alternative to or in combination with the weld points, be affixed to each pipe length 44, 46 in a friction fit. Other methods and mechanisms for coupling the pipe lengths to the coupling are also known in the art.

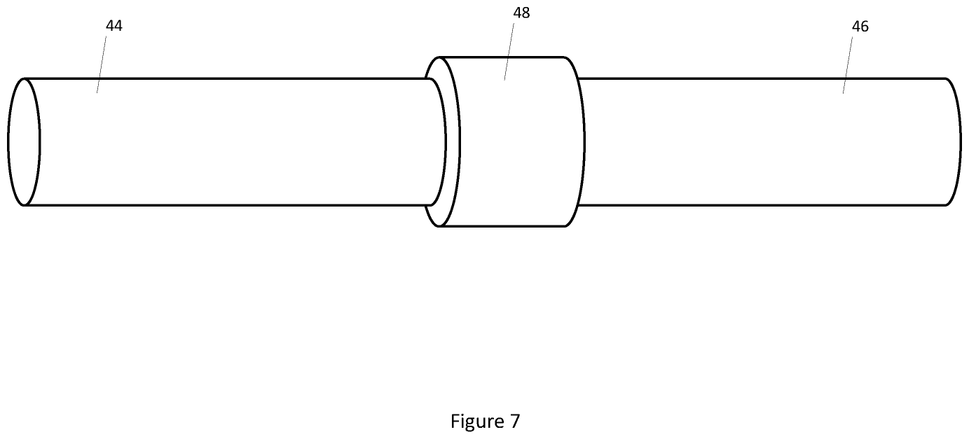

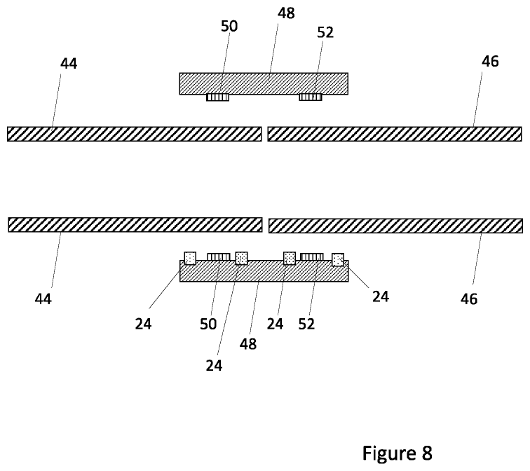

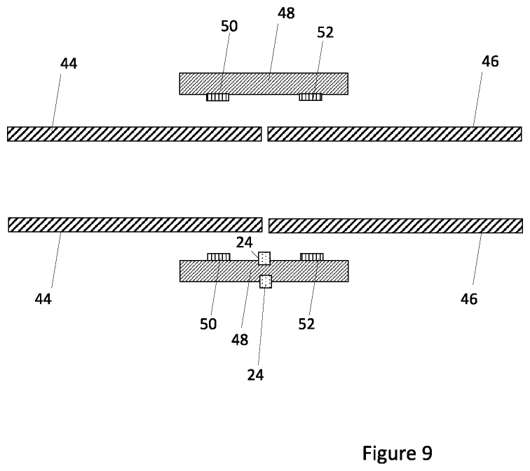

FIG. 8 shows a schematic cross-section of the composite pipe joint of FIG. 7. Pipe lengths 44 and 46 are joined together at pipe coupling 48. Pipe coupling 48 comprises wire mesh 50, 52 which surround the inner surface of the coupling 48. Pipe coupling 48 also comprises RFID tag hydrocarbon sensors 24 which are located on the inner surface of the pipe coupling 48, between the outer edge of the pipe coupling 48 and each respective wire mesh 50, 52. Alternatively, as shown in FIG. 9, pipe coupling 48 may comprise RFID tag hydrocarbon sensor 24 located on the outside surface of the pipe coupling 48. As drawn, since the drawing is a cross-section, the hydrocarbon sensors 24, 24 are shown in line with the bottom of the coupling (as installed on the pipe), but it would be evident that the hydrocarbon sensors 24 may be located at any point along the circumference of the coupling 48 to the same effect. Pipe coupling 48 also comprises RFID tag moisture sensors 24 (alternatively, as shown in FIG. 8, a single RFID tag moisture sensor 24) between wire meshes 50, 52 on the inner surface of the pipe coupling 48. Again, as drawn, since the drawing is a cross-section, the moisture sensors 24 are shown in line with the bottom of the coupling (as installed on the pipe), but it would be evident that the moisture sensors 24 may be located at any point along the circumference of the coupling 48 to equivalent effect.

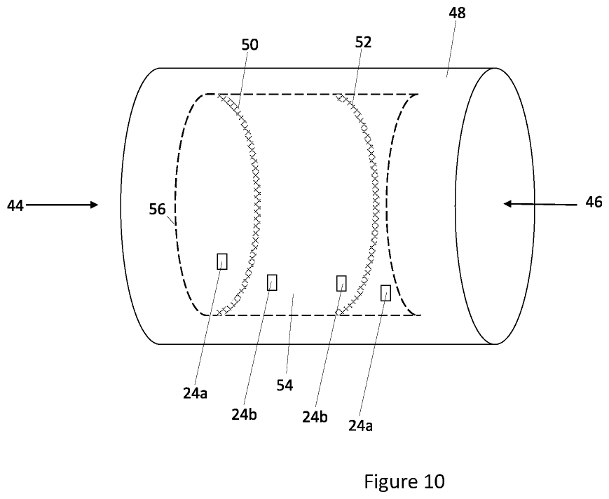

FIG. 10 shows a schematic, cut-out, perspective view of a pipe coupling 48 as shown in FIG. 4. Note that like all drawings in this application, the drawing is not to scale. Pipe coupling 48 has wire mesh 50, 52 arranged around the diameter of its inner surface 54 (seen through cut-out 56). Pipe coupling 48 also has RFID hydrocarbon sensors 24 on its inner surface, with hydrocarbon sensor 24a located between wire mesh 50 and its respective pipe coupling opening 44, and hydrocarbon sensor 24a located between wire mesh 52 and its respective pipe coupling opening 46. In this manner, when pipe coupling 48 is fused to pipes 44, 46 at wire mesh 50, 52, hydrocarbon sensors 24a will only come into contact with hydrocarbon if it is present outside the pipe, or if it has passed through the fused sections of pipe at wire mesh 50, 52. Thus, this configuration detects failures at the pipe coupling when the pipe is filled with hydrocarbon and the exterior environment is devoid of hydrocarbon.

Likewise, moisture sensors 24b are located interior to wire mesh 50, 52, and therefore, when pipe coupling 48 is fused to pipes 44, 46 at wire mesh 50, 52, moisture sensors 24b will only come into contact with moisture if there is ingress from the outside environment into the pipe, when the pipe carries hydrocarbon and no moisture.

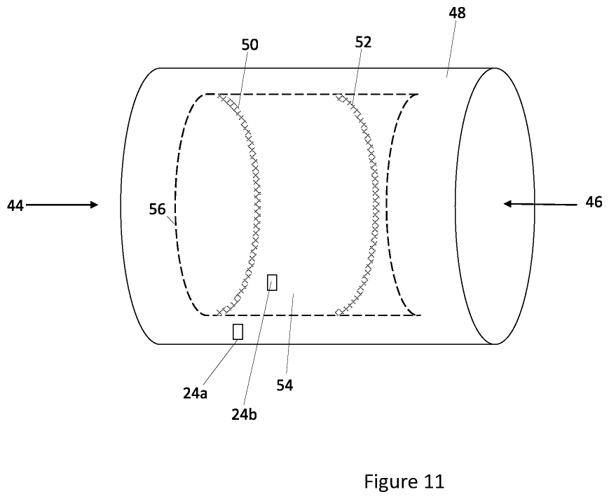

FIG. 11 shows a schematic, cut-out, perspective view of the pipe coupling of FIG. 9 in a similar manner. Since moisture sensor 24b is between the two fusion points (located at wire mesh 50 and 52), there is only need for one moisture sensor. Since hydrocarbon sensor 24a only needs to detect hydrocarbon outside of the pipe, it does not need to be located on the interior surface of the pipe coupling 48, and instead can be located on the outside of the pipe coupling 48. It is noted that the designs of the couplings and joint configurations can vary substantially. The placements of the sensors would be adapted accordingly for the detection of the presence of the moisture and hydrocarbons, emanating from inside or outside the pipe.

In certain applications, pipe couplings can be used with an inner spacer; in such applications, the sensors may be appropriately affixed to or otherwise located on such inner spacers.

In addition to, or in alternative to described embodiments, it may be desirable to have the herein described RFID tag sensors affixed or imbedded into either the outside surface or the inside surface of the composite pipes themselves; the presence of the sensors inside the main pipe section could allow detection of moisture or hydrocarbons inside the pipe; presence of the sensors on the outside surface could detect leaks.

Same consideration also applies for the steel pipe joints where different types of coverings are used, and the sensor placements are accordingly customized.

As would be understood to a person of skill in the art, RFID tag sensors as utilized in the present invention are extremely cheap and robust. Redundancy is an important feature of any pipeline leak detection system. Accordingly, though the couplings shown in FIGS. 7-11 show only one or two moisture sensors, and one or two hydrocarbon sensors, it may be desirable, in certain configurations, to utilize a plurality of sensors, for redundancy. In certain embodiments, each sensor may have its own unique identifier. In other embodiments, each sensor on a coupling may have the same identifier, to identify the coupling.

Application 6: RFID Tag in Steel Pipe Coupling

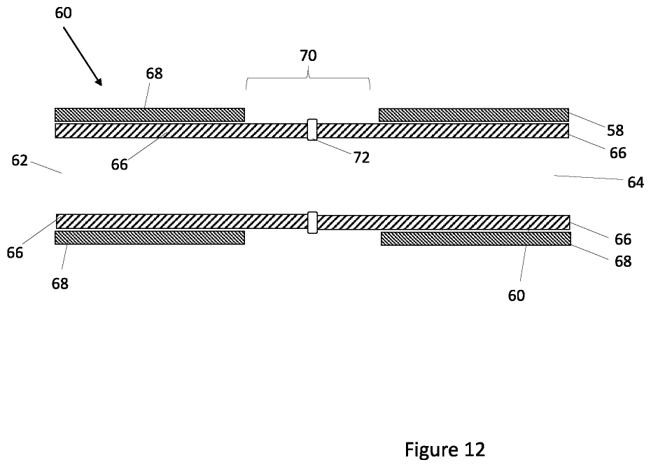

FIG. 12 shows a typical steel pipe girth weld, in schematic cross section view. Pipeline 60 comprises pipes 62, 64, which are multi-layer pipes, comprising a steel conduit 66 that is coated in the factory with factory coating 68. Factory coating 68 may be a single coating, for example, fusion bonded epoxy, or, more typically, is a multi-layer coating, for example having a fusion bonded epoxy anti-corrosion layer directly on the steel, with a polyethylene impact resistance layer over top of the epoxy.

The ends of pipes 64, 66 are left uncoated at their ends defined by cutback region 70, to facilitate welding them together. Steel conduit 66 of pipes 64, 66 are welded together at girth weld 72. In order to prevent corrosion at the exposed steel of the cutback region 70, or, for example, at girth weld 72, a corrosion resistance coating must be provided for the cutback region 70.

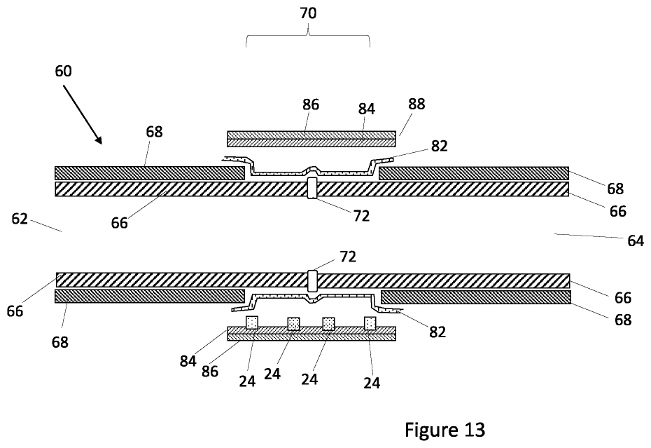

Such a corrosion resistance coating is shown, applied to the pipe 60, in FIG. 13. First, the entire cutback region 70, and optionally a small portion of the factory coating 68 proximal to the cutback region 70, is coated with an anti-corrosion coating, such as a thin layer of liquid fusion bonded epoxy (FBE coating 82). Then a shrink sleeve 88 or wrap is applied to the cutback region for impact protection and for protection of the FBE coating 82. The shrink sleeve 88 or wrap of the present invention may be based on any known shrink sleeve or wrap technology; as shown shrink sleeve 88 is a two layer sleeve comprising an inner adhesive layer 84 which, when heated, softens, flows, and bonds to the FBE coating 82, and an outer polyolefin layer 86 which is a pre-stretched polyolefin designed to be heat shrunk to tightly bind to the pipe. Sometimes, instead of a shrink sleeve, one may use cold-applied or hot applied tapes to form single or multilayer coating over the joint. Sometimes the polyolefin coating is extruded in a sheet form in situ using a mini-extruder device. These systems for protection of the joint are often referred to as FJC or the ‘field joint coatings” in the industry.

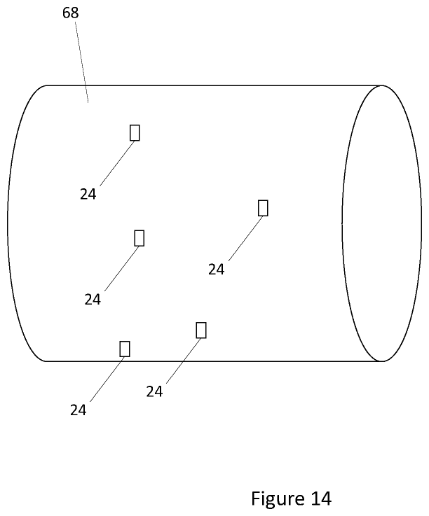

Also shown in FIG. 13 are a plurality of hydrocarbon and moisture sensors 24. Although shown in cross section as at the very bottom of the sleeve 88, the sensors 24 may be located anywhere on the inside of the sleeve. Typically, and as shown, the sensors 24 are partially imbedded in, or affixed to, the adhesive layer 84. RFID sensors 24 may also be affixed to or partially imbedded into the outside of the sleeve, as shown in FIG. 14. Alternatively, the sensors could be placed on the epoxy layer already on the pipe joint surface, and then joint coating is applied on top of them. It is noted that sometime epoxy is not used and joint coating is applied directly on to the steel substrate, in which case the sensors could be placed directly onto the steel substrate before coating.

Each sleeve may have unique identifiers associated with each sensor affixed thereto, or a unique identifier for the sleeve itself, or both.

In an alternate, or additive, arrangement, sensors can be applied under or within the factory coating 68 during the coating application process in the factory. This would allow monitoring of the pipe for corrosion due to moisture ingress resulting from a breach in the coating or hydrocarbon leakage due to a breach in the pipeline steel. Sensors could also be affixed to, partially imbedded into the outside of the factory coating, to monitor hydrocarbon egress from the pipeline. The sensors may also be completely imbedded into the coating and installed in the coating as part of the pipeline coating process. It is noted that certain steel pipes have multiple layers of coating, including optionally an insulation layer and/or a concrete layer; it would be appreciated that sensors could equally be affixed to, partially imbedded into, or completely imbedded into any such layer.

Application 7: Other Configurations

As can be appreciated, the RFID sensors 24 of the present invention may be affixed to the outside of the pipe, or in just about any other reasonable configuration. For example, RFID sensors 24 may be pre-affixed or imbedded into/onto shrink sleeves or wraps at the factory.

As shown, and in certain desirable embodiments, the RFID sensors are battery-less, passive sensors, which receive required energy from an RF interrogator when the sensor is read. However, as can be appreciated, in certain applications, it may be desirable to use an RFID sensor with an integrated power supply, such as a battery, for enhanced communication, especially in buried applications, where the terrain and distance can be obstacles to using a passive sensor. An example of such battery operated sensor is the MiniSensor from Disruptive Technologies Research AS, Bergen, Norway. This is a tiny sensor, 2 mm thickness and size 19×19 mm. This carries miniature battery that could last 10-25 years depending on the usage frequency. The flat and thin structure lends itself to be embedded into certain pipe coating or composite pipe configurations. We have found that the parameters that can hinder the signal transmission for buried pipelines are the depth of pipe, usually beyond 4 ft of dry light soil and 2 ft of wet heavy (claylike) soil. The rocks and stone aggregates were also found to create major disruptions in the signal exchange. In the subzero temperatures, the frost layers form in the soil and they also were found to affect the transmission. In some cases using high frequency interrogators, e.g. >2.5 GHz and 4 watts of power increased the signal penetration capacity in the difficult terrains. However, in the pipeline construction, the variables are sometimes unpredictable. One may design the sensor tag and interrogator capacity based on the known depth and prevailing soil conditions with extra margin of safety for certain changing conditions.

Methods and Systems for Interrogation of RFID Sensors

The RFID sensors, and pipelines having imbedded RFID sensors, of the present invention, can be utilized in systems for measuring the health of a pipeline.

Method 1: Land-based Reader/Interrogator/Antenna

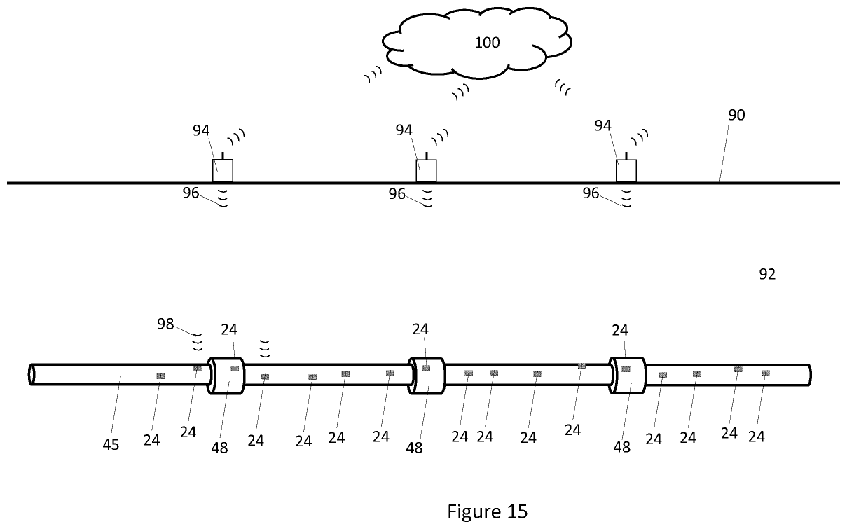

FIG. 15 shows a buried pipeline of the present invention. Shown is a composite pipeline 60 having a plurality of couplings 48 as hereinbefore described. As can be appreciated, in an alternate arrangement, the pipeline could be a steel pipeline having a plurality of girth welds coated in shrink sleeves as hereinbefore described. The pipeline has a plurality of RFID sensors 24, configured in one or more of the configurations described above. The pipeline may have only one kind of RFID sensor 24, for example, a plurality of hydrocarbon RFID sensors (as hereinbefore described), or it may have a variety of different types of sensors, such as moisture RFID sensors, hydrocarbon RFID sensors, strain RFID sensors, and temperature RFID sensors, as described above.

The pipeline is depicted as underground, with ground 90 and soil 92 shown. Above ground is depicted RFID sensing stations 94, spaced apart from one another and following the path of the buried pipeline 45. RFID sensing stations 94 each comprise an RF interrogator or transceiver, which each communicate with a plurality of the RFID sensors 24, by sending energy 96 to and receiving back a corresponding signal 98 back from the RFID sensors 24, through the soil 92. RFID sensing stations 94 are powered, and can be powered either through conventional means such as a power line or battery, or through a solar cell. RFID sensing stations 94 are in a sealed terminal box, and read multiple RFID sensors 24 within their range. For example, each RFID sensing station 94 may be able to read hundreds of RFID sensors 24, each having a unique ID, and each within the sensing station 94's range of sensing. Alternatively, each sensing station 94 may be dedicated to one RFID sensor 24 on the pipeline, or to one coupling 48. One advantage of this system is that the RFID sensing stations 94 are user accessible in the case of failure, since they are located above ground. Typically, RFID sensing stations 94 are sealed in a weatherproof housing and can withstand the elements. RFID sensing station 94 can communicate, using known wireless technologies, such as a wireless cellular signal, to the cloud 100 or to a dedicated central station (not shown). In certain embodiments, RFID sensing stations 94 are programmed to interrogate the RFID sensors on a regular basis, for example, once per day; in other embodiments, the RFID sensing stations 94 continuously interrogate the RFID sensors. In certain embodiments, the signals are sent to the cloud 100 or to the central station regardless of whether hydrocarbon, stress, temperature changes or moisture is detected (both positive and negative signals); in other embodiments, a signal is only sent back to the central station when hydrocarbon, moisture, strain, or temperature change is detected. In certain embodiments, a combination of readings from different sensors (different types of sensors, and/or different sensors of the same type, proximal to one another) can be used in a machine learning algorithm, a fuzzy logic system, or another algorithm, to increase sensitivity or accuracy of findings.

Method 2: Buried Interrogator Antenna

One of the advantages of the Land based interrogator/reader system described in method 1, above, is that it requires no buried parts (apart from the pipeline). This means it is robust, easily serviceable, and easy to deploy. However, one of the disadvantages of such a system is that ground-based interrogators have limited range, since the interrogation signal must be sent a fair distance through soil 92.

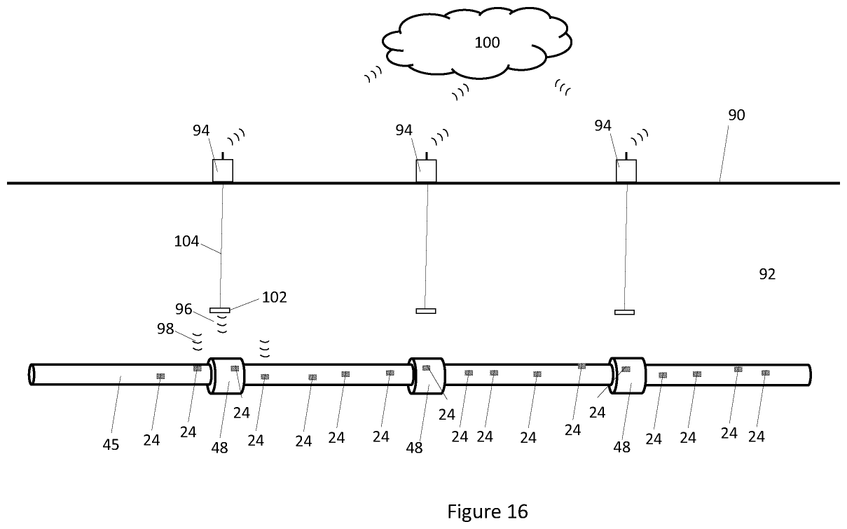

An alternate system and method is described in FIG. 16. Here, like in Method 1, the method and system relates to a buried pipeline 45. The buried pipeline 45 has a plurality of couplings 48, and a plurality of RFID sensors 24, either within the couplings 48, or elsewhere within the pipeline 45. Alternatively (for all of the examples, but not shown), the RFID sensors 24 may be buried proximate to the pipeline 45, and would be effective, for example, for detecting hydrocarbon leaks proximate to the pipeline 45.

Like method 1, the Buried Interrogator Antenna system and method comprises a plurality of above-ground RFID sensing stations 94. However, unlike method 1, where the above-ground RFID sensing stations 94 were self-contained units encompassing both an interrogator and an reader antenna, method 2 comprises separate, buried reader antennas 102, which are hard-wired to RFID sensing stations 94 by cable 104, which may for example be a co-axial cable. Buried interrogator antennas 102 provide the advantage of proximity to RFID sensors 24, while maintaining most of the robustness and serviceability of an above-ground RFID sensing station 94.

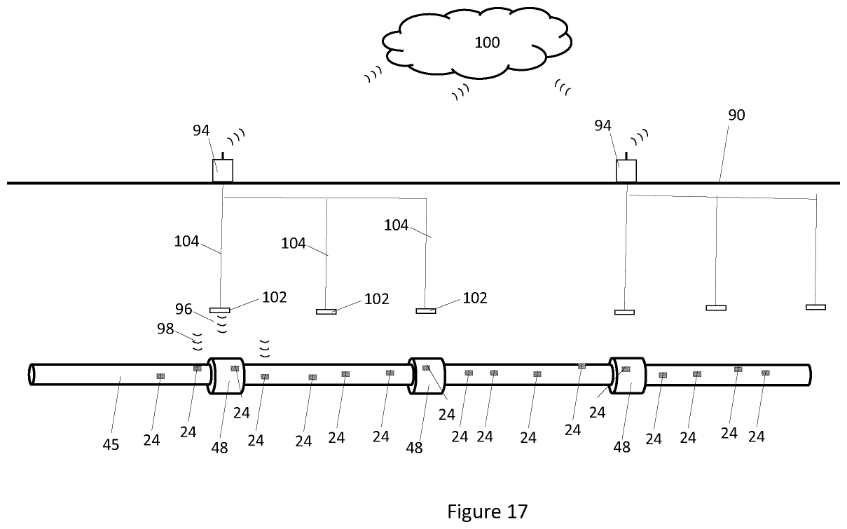

An alternate embodiment of the Buried Interrogator Antenna method is shown in FIG. 17; here, each above-ground RFID sensing station 94 may have a plurality of buried antennas 102, each hard wired and each servicing a different and/or overlapping region of the pipeline 45.

In certain embodiments, the reader antennas 102 are buried when the RFID sensing stations 94 are built. However, in a preferred embodiment, the antennas 102 are attached to the pipe surface, and buried together. The cable 104 is extended from the antenna to the ground surface, where a terminal connection is available in a sealed NEMA. The RFID sensing stations 94 could be connected to the sealed NEMA at a later date. Alternatively, a local mobile reader could be temporarily attached to the NEMA when desired, for discrete readings that would not necessitate the infrastructure of the RFID sensing stations 94.

Method 3: Mobile Above-ground Interrogation

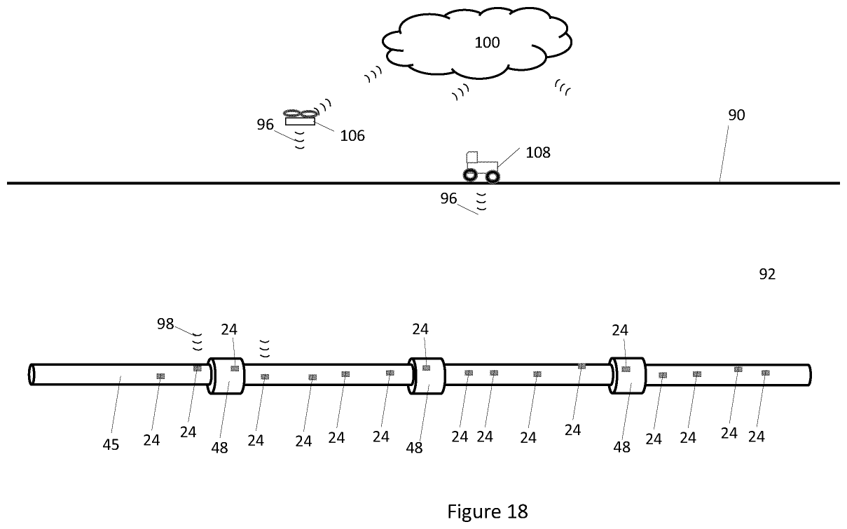

Alternatively, instead of having permanent above-ground RFID sensing stations like in methods 1 and 2, the RFID sensing stations may be mobile, as depicted in FIG. 18. For example, the RFID interrogator may be configured within an unmanned aerial vehicle or drone 106, or a manned aerial vehicle, which would fly the path of the pipeline 45, interrogating the RFID sensors 24. The RFID interrogator may also be hand-held and transported by an operator, or configured within a vehicle 108, for example an autonomous automobile or an inspection team traversing the right of way over the pipeline route and manually interrogating the RFID sensors 24. In these examples, the RFID interrogator may be read by an operator on site, or, as depicted, may be connected wirelessly to the cloud 100 or to a dedicated central station as previously described.

Method 4: Pig Interrogation

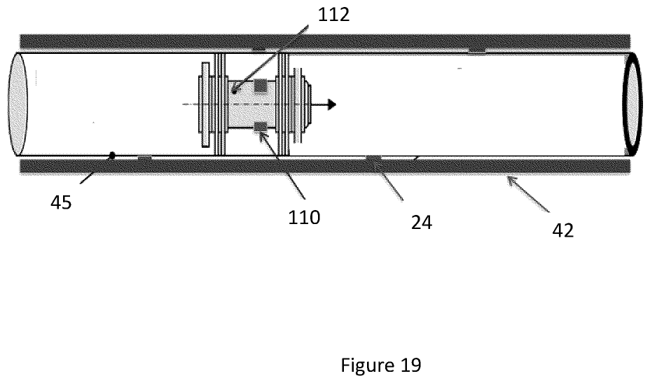

In certain pipeline installations, it may be difficult or impossible to utilize the interrogation methods and apparatus described in Methods 1-3. This may be the case, for example, for certain deep sea pipelines, where the sea conditions make it difficult to have a proximal antenna, and the depth of the water make it difficult to transmit sufficient energy to interrogate the RFID sensors. In these cases (and where otherwise desirable), interrogation may be done through an RFID reader 110 mounted on a pig 112 (sometimes known as a pipeline intervention gadget), as depicted in FIG. 19. The pig 112 travels inside the pipeline, and is typically deployed within the fluid flow in the pipeline. Pigging a pipeline is a well established art. One advantage of Pig interrogation is that the pig, being inside the pipeline, is quite proximal to any RFID sensors 24 contained within the pipeline. This method is especially useful for sensing of RFID sensors 24 contained within a concrete coated pipeline.

The “pigging” of the pipeline can be done without removing the contents of the pipeline in a section of pipe, and utilizing the pressure-driven flow of the oil or gas travelling within the pipeline to displace the pig. Alternatively, the “pigging” of the pipeline can be done by first removing the contents of a section of the pipeline, and “pigging” that section. In the latter case, it would be appreciated that the “pig” would need its own locomotive force; the pig can either be equipped with a power source (such as a battery) which powers wheels for locomotion, or can be pulled or towed along the pipe conduit by a rope, or a pig tractor.

During a pigging run, typically, a pig is unable to directly communicate with the outside world, due to the distance underground or underwater, and due to the thickness of the pipe. Accordingly, positioning data for the pig can be obtained utilizing known technologies, such as odometers, gyroscope-assisted tilt sensors, or other technologies. Positioning data can also be obtained using unique identifiers read from the RFID chips incorporated in the pipeline coating or coupling/sleeve-wrapped girth welds, where the location of those RFID chips have previously been mapped.

Method 5: Other RFID Sensor Placements

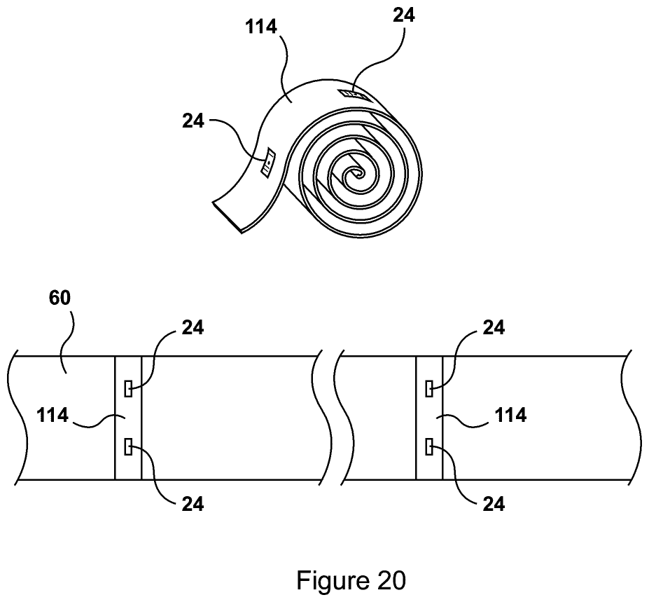

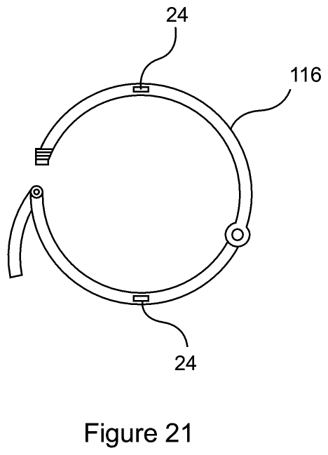

In a further embodiment, an RFID sensor, such as an External Battery RFID Tag (EBRT) sensor, may be mounted, affixed, or attached onto a pipeline. As can be appreciated, such mounting may be on a new pipeline, or, where accessible (i.e. above ground), an existing pipeline may be retrofit. For example, as depicted in FIG. 20, one or more RFID sensor 24 may be incorporated into or onto a wraparound tape 114, for wrapping around and affixing to the pipeline. Such a sensor-containing tape 114 may be wrapped around a pipe 60, for example, every five meters, to provide point readings at every five meters of pipe. Likewise, as shown schematically in FIG. 21, the sensor may be incorporated onto or into a clamp 116 which can be permanently or semi-permanently clamped around the pipeline, or can be incorporated into a spring-loaded composite sheet like the Clock Spring™, (Clock Spring Company, Inc., Houston, Tex.) and applied onto the pipe with a suitable adhesive, for example, polyurethane. For clamped or Clock Spring applied sensors, a strain sensor would work well.

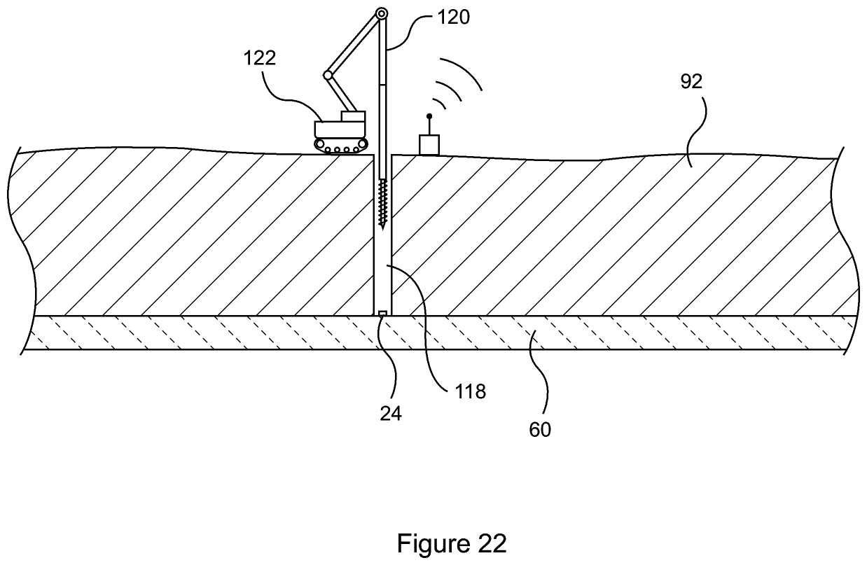

Buried pipeline can also be retrofitted with the hereindescribed sensors, as follows, and as shown in FIG. 22. A narrow borehole 118 can be drilled into the soil utilizing drill 120 controlled from truck 122, or alternatively (not shown) a manual drilling apparatus may be used, for shallowly buried pipe or as appropriate given the soil makeup. Once the pipe surface is contacted, it is cleaned with a remotely controlled tool, and a sensor 24 is adhesively attached, utilizing robotic equipment. The borehole 118 is then buried.

For buried pipeline, EBRT sensors are advantageous, since they have longer range. A gateway, such as RFID sensing station 94 may be installed near the borehole 118, for receiving data from the buried sensor 24. The gateway may store the information locally, or transmit to a cloud-based or other wireless network. The gateway may continuously receive data from the sensor 24, interrogate the sensor 40 at a defined time interval, or on an as needed basis, when a query is sent to it from a remote location via the cloud-based or other network.

### PARTS LIST

2—RFID Sensor
4—carrier Substrate
6—Chip
8—Tag antenna
10—inlay
12—cover-film
14—pipe section
16—inner layer
18—intermediate layer
20—outer layer
22—conduit
24—sensor RFID tags
26—insulated pipe
28—steel pipe
30—fbe layer
32—insulation layer
34—top coat layer
36—3-layer PE pipe
38—outer coating
40—concrete coated pipe
42—concrete coating
44—first composite pipe
45—composite pipeline
46—second composite pipe
48—composite pipe coupling
50—wire mesh
52—wire mesh
54—coupling inner surface
56 cut-out
60—pipeline
62—Pipes
64—pipes
66—steel conduit
68—factory coating
70—cutback region
72—girth weld
82—FBE coating
84—inner adhesive layer of shrink sleeve
86—outer polyolefin layer of shrink sleeve
88—shrink sleeve
Tape 114
Clamp 116
Borehole 118
Drill 120
Truck 122

1. A pipeline monitoring system, comprising:
a pipeline having at least one RFID sensor for a wireless remote detection of any one or more of pipeline conditions including hydrocarbons presence, moisture presence, temperature and strain, and
an RF interrogator or transceiver capable of interrogating said sensor,
wherein the at least one RFID sensor is located on the outside coating of the pipeline, proximal to the pipeline, within the pipeline coating, or on a pig within the pipeline.

2. A pipeline monitoring system of claim 1 further comprising a controller for said RF interrogator or transceiver, a memory for storing data received from said interrogating, and a power source for powering said RF interrogator or transceiver and said controller.

3. A pipeline monitoring system of claim 1, whereby the RF interrogator or transceiver is positioned on or in the vicinity of the pipeline.

4. A pipeline monitoring system of claim 3, wherein the pipeline is a buried pipeline and the RF interrogator or transceiver is positioned above ground.

5.-10. (canceled)

11. The pipeline monitoring system of claim 1-4 wherein the RFID sensor comprises a hydrocarbon-sensitive cover-film.

12. The pipeline monitoring system of claim 11 wherein the hydrocarbon-sensitive cover-film comprises silicone, ethylene vinyl acetate or a styrene butadiene rubber.

13. The pipeline monitoring system of claim 1 wherein the RFID sensor comprises a moisture sensitive chip and a cover-film.

14. The pipeline monitoring system of claim 1 wherein the RFID sensor comprises a temperature sensitive microchip.

15. The pipeline monitoring system of claim 14, wherein the sensor is reversible to presence or absence of moisture.

16. The pipeline monitoring system of claim 14, wherein the sensor is irreversible to the presence of moisture.

17. The pipeline monitoring system of claim 1 wherein the RFID sensor comprises a strain sensor.

18. The pipeline monitoring system of claim 11, wherein the sensor comprises a strain sensitive microchip.

19. The pipeline monitoring system of claim 11, wherein the strain sensor comprises a conductive crosslinked polymer.

20. The pipeline monitoring system of claim 13, wherein the conductive crosslinked polymer comprises silicone filled with a conductive filler.

21. The pipeline monitoring system of claim 14 wherein the conductive filler is carbon black, carbon nanotubes, graphene and/or a metallic powder.

22. (canceled)

23. A coated or insulated pipe, or a multilayered composite or plastic pipe, comprising a at least one RFID sensor for a wireless remote detection of any one or more of pipeline conditions including hydrocarbons presence, moisture presence, temperature and strain.

24. The coated pipe or insulated pipe of claim 16 wherein the RFID sensor is imbedded in or under the coating, in between any of the layers, or mounted on top of the coating.

25.-26. (canceled)

27. A pipeline coupling comprising at least one RFID sensor for a wireless remote detection of any one or more of pipeline conditions including hydrocarbons presence, moisture presence, temperature and strain.

28. The pipeline coupling of claim 20 wherein the RFID sensor is located on an interior surface of the coupling, distal to a pair of weld points circumscribing the interior of the coupling, or on an exterior surface of the coupling.

29. (canceled)

30. A heat shrinkable sleeve or field joint coating comprising at least one RFID sensor for a wireless remote detection of any one or more of pipeline conditions including hydrocarbons presence, moisture presence, temperature and strain.

31.-37. (canceled)

38. The shrinkable sleeve or field joint coating of claim 20 comprising an inner adhesive layer and an outer pre-stretched, heat shrinkable polyolefin layer, wherein
the RFID sensor is partially imbedded in, or affixed to, the inner adhesive layer or the outer pre-stretched, heat shrinkable polyolefin layer.

39. A pipeline monitoring system for an underground or above ground pipeline having a plurality of couplings, sleeves or field joint coatings of claim 1, comprising:
one or more above-ground RFID sensing stations, each located proximal to the pipes and to one of said plurality of couplings, sleeves, or field joint coatings said RFID sensing stations comprising an RF interrogator or transceiver capable of interrogating the RFID sensor located on said pipe, coupling or sleeves or field joint coatings
and a wireless signal sending means for sending a signal correlating to said interrogation to a remote base station.
